(19) United States
(12) Patent Application Publication
(10) Pub. No.: US 2016/0228875 A1
(43) Pub. Date: Aug. 11, 2016

(54) Thermal Cycler Cover

(71) Applicant: LIFE TECHNOLOGIES CORPORATION, Carlsbad, CA (US)

(72) Inventors: Tiong Han Toh, Singapore (SG); Wuh Ken LOH, Singapore (SG); Kuan Moon BOO, Singapore (SG); Sandro David KLEIN, Irvine, CA (US); Daniel WELSH, Encinitas, CA (US)

(21) Appl. No.: 14/778,106

(22) PCT Filed: Feb. 14, 2014
(86) PCT No.: PCT/US2014/016397

§ 371 Date: Sep. 18, 2015

Related U.S. Application Data
(60) Provisional application No. 61/803,390, filed on Mar. 19, 2013.

(51) Int. Cl. B01L 7/00

(52) U.S. Cl. CPC B01L 7/52; B01L 2300/043; B01L 2300/1822

(57) ABSTRACT

In one aspect, a thermal cycler system is disclosed. The thermal cycler can be comprised of a device housing and a cover that is operably connected to the device housing. The cover can include a handle portion, a device lid portion, a sample block platen and a link bar. The device lid portion is attached to the proximal side of the handle portion with a pin. The sample block platen is operably connected to the handle portion such that the sample block platen is positioned against the sample block when the handle portion is flush with the device lid portion and the cover is in a closed position. The link bar is operably connected to the device housing and the pin such that a distal side of the handle portion is elevated away from the device lid portion when the cover is moved to an open position.

### APPLICATIONS FOR CLAIM OF PRIORITY

This application claims the benefit under 35 U.S.C. §119(e) of U.S. Provisional Application Ser. No. 61/803,390 filed Mar. 19, 2013. The disclosure of the above-identified application is incorporated herein by reference as if set forth in full.

### FIELD

Provided herein are systems and apparatuses for providing a heated cover on a thermal cycler, and limiting access to the heated platen.

### BACKGROUND

A thermal cycler's well tray area requires a cover with a good seal, and a tight fit with even pressure across the top of the well tray. This eliminates any condensation build-up, and ensures the tray is securely pressed into the thermal block for both even and accurate thermal transfer during cycles. With many instruments, including the APPLIED BIOSYSTEMS' models VERITI™, 2720 and PROFLEX™, when the heated cover is open, the handle is further behind. So, when closing, the user may inadvertently grab the heated cover instead, and possibly burning themselves, or pinching their fingers when swinging the handle over when locking down. Moreover, the user can sometimes mistakenly think that the tray clamp is in place, even when its not, when the cover is in a dosed position.

Previous designs have sought to solve this problem by incorporating a heated cover with a locking handle or latch to ensure the cover is securely closed, and a combination of a crank, spin wheel or knob, to put even pressure over the well tray without damaging it. These previous designs, however, have not provided mechanisms or features to allow the safe handling of the heated cover and ensure that the tray clamp is fully engaged when the cover is closed. The present teachings address the deficiencies of the previous designs.

### DRAWINGS

For a more complete understanding of the principles disclosed herein, and the advantages thereof, reference is now made to the following descriptions taken in conjunction with the accompanying drawings, in which:

FIG. 1 is an illustration of a thermal cycler system with an improved cover, in accordance with various embodiments.

FIG. 2A is an illustration of a cover with a handle portion that is in an elevated position relative to a device lid portion, in accordance with various embodiments.

FIG. 2B is an illustration showing an expanded view of how a pin latches onto the elliptical slot opening of the handle portion, in accordance with various embodiments.

FIG. 3A is an illustration of a cover with a handle portion flush with a lid portion, in accordance with various embodiments.

FIG. 3B is an illustration showing an expanded view of how a platen pin latches onto the platen slot opening of the handle portion, in accordance with various embodiments.

FIG. 4A is an illustration of an unlatched cover, in accordance with various embodiments.

FIG. 4B is an illustration of a latched cover, in accordance with various embodiments.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### SUMMARY

Systems and apparatuses for providing a heated cover on a thermal cycler are described herein.

In one aspect, a thermal cycler system is disclosed. The thermal cycler can be comprised of a device housing and a cover that is operably connected to the device housing. The device housing can include a sample block with a top and a bottom surface and a thermal electric device in thermal communication with the bottom surface.

The cover can include a handle portion, a device lid portion, a sample block platen and a link bar. The device lid portion is attached to the proximal side of the handle portion with a pin. The sample block platen is operably connected to the handle portion such that the sample block platen is positioned against the sample block when the handle portion is flush with the device lid portion and the cover is in a closed position. The link bar is operably connected to the device housing and the pin such that a distal side of the handle portion is elevated away from the device lid portion when the cover is moved to an open position.

In another aspect, a device cover is disclosed. The device cover can be comprised of a handle portion, a device lid portion and a link bar. The device lid portion can be attached to a proximal side of the handle portion with a pin. The link bar can be operably connected to the device housing and the proximal side of the handle portion such that a distal side of the handle portion is elevated away from the device lid portion when the cover is moved to an open position.

These and other features, aspects, and embodiments of the invention are described below in the section entitled “Description of Various Embodiments.”

### DESCRIPTION OF VARIOUS EMBODIMENTS

Embodiments of systems and apparatuses for providing a heated cover on a thermal cycler are described herein. Details of the various embodiments of these systems and apparatuses are illustrated with reference to the exemplary and non-limiting drawings included with this specification.

It will be appreciated that there is an implied “about” prior to the temperatures, concentrations, times, number of bases, coverage, etc. discussed in the present teachings, such that slight and insubstantial deviations are within the scope of the present teachings. In this application, the use of the singular includes the plural unless specifically stated otherwise. Also, the use of “comprise”, “comprises”, “comprising”, “contain”, “contains”, “containing”, “include”, “includes”, and “including” are not intended to be limiting. It is to be understood that both the foregoing general description and the following detailed description are exemplary and explanatory only and are not restrictive of the present teachings.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

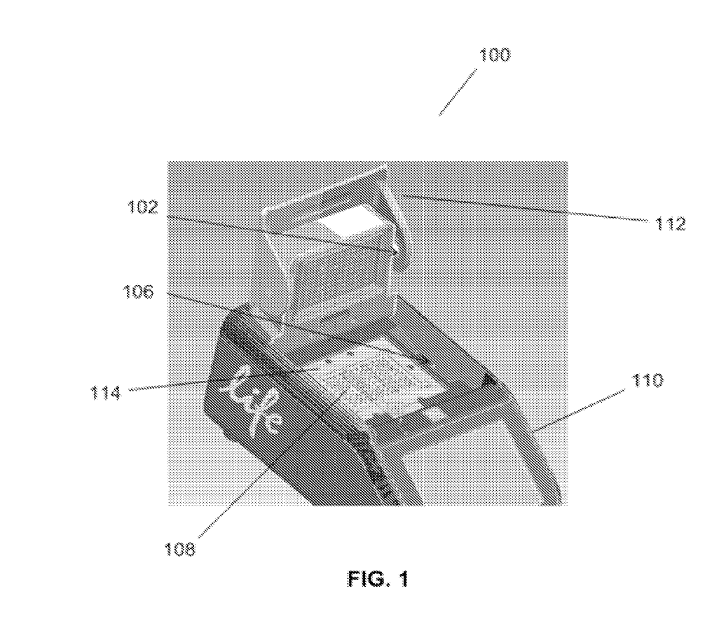

FIG. 1 is an illustration of a thermal cycler system with an improved cover, in accordance with various embodiments. As depicted herein, the thermal cycler system 100 can include a device housing 110 and a cover 112.

In various embodiments, the device housing 110 can include a sample block 108 having a top and a bottom surface. The cover 112 can be operably connected to the device housing 110 by way of a hinge, a pin or other equivalent attachment mechanism that can pivot the cover 112 from an open position to a close position and vice versa. The cover 112 can include a latch 102 that is configured to latch onto a latch block 106 on the device housing when the cover 112 is in a closed position. In various embodiments, the latch block 106 extends from a drip pan 114 that houses the sample block 108. In various embodiments, the latch block 106 is attached to the drip pan 114 housing the sample block 108.

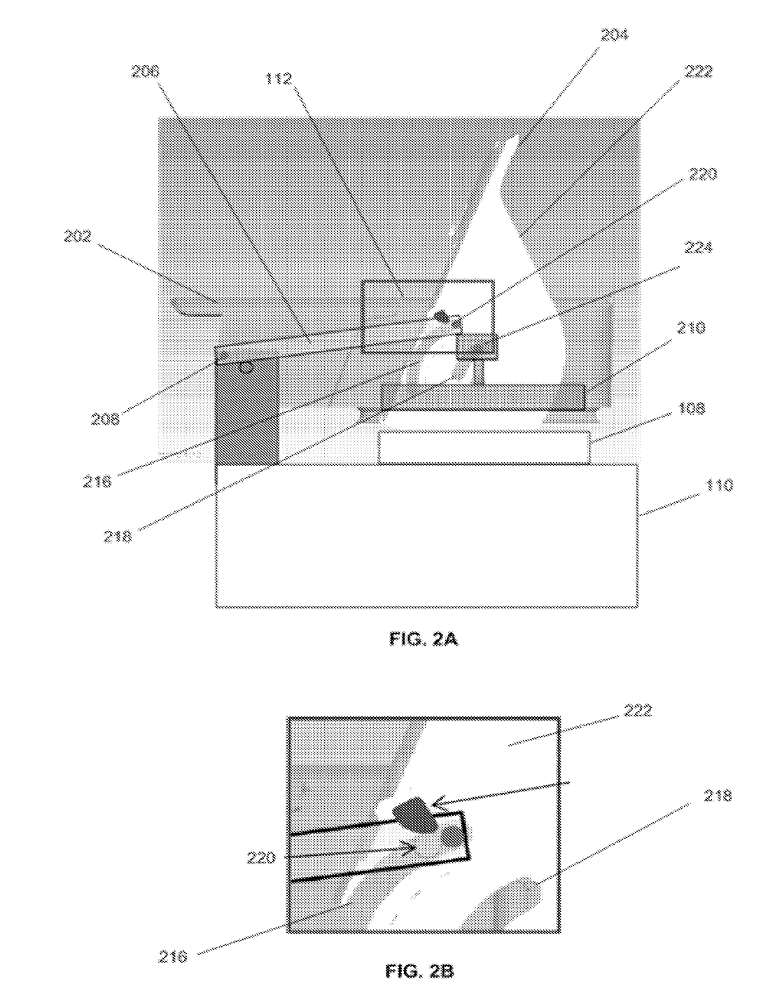

FIG. 2A is an illustration of a cover with a handle portion that is in an elevated position relative to a device lid portion, in accordance with various embodiments.

As depicted herein, a thermal cycler system can include a device housing 110 and a cover 112. The device housing can include a sample block 108 with a top surface and a bottom surface. In various embodiments, the top surface of the sample block 108 can include one or more openings or wells to receive sample vials or well array plates containing a nucleic acid sample and reagents for amplifying the nucleic acid sample using a polymerase chain reaction (PCR) process. In various embodiments, the bottom surface of the sample block 108 is in thermal communication with a thermal electric device.

In various embodiments, the thermal electric device can be a Peltier thermoelectric device that can be constructed of pellets of a n-type and p-type semiconductor material that are alternately placed in parallel to each other and are connected in series. Examples of semiconductor materials that can be utilized to form the pellets in a Peltier device include, but are not limited to, bismuth telluride, lead telluride, bismuth selenium and silicon germanium. However, it should be appreciated that the pellets can be formed from any semiconductor material as long as the resulting Peltier device exhibits thermoelectric heating and cooling properties when a current is run through the Peltier device. In various embodiments, the interconnections between the pellets can be made with copper which can be bonded to a substrate, usually a ceramic (typically alumina).

In various embodiments, the cover 112 can be comprised of a handle portion 222, a device lid portion 202, a sample block platen 210 and a link bar 206. The device lid portion 202 can be attached to a proximal side of the handle portion 222 with a pin 220. As used herein, the proximal side of the handle portion 222 denotes the side nearest the attachment point between the handle portion 222 and the device lid portion 202.

FIG. 2B is an illustration showing an expanded view of how a pin 220 latches onto the elliptical slot opening 216 of the handle portion 222. As shown herein, the pin 220 protrudes from the device lid portion 202 and latches onto an elliptical slot opening 216 on the proximal side of the handle portion 222. In various embodiments, the pin 220 is an unbroken part of the device lid portion 202. In various embodiments, the pin 220 is a separate part that is secured and/or attached to the device lid portion 202. A link bar 206 is operably connected to the device housing 110 and the pin 220 such that the distal side of the handle portion 202 is first elevated away from the device lid portion 202 before the cover 112 can be moved to an open position. This sequence occurs because the distal side of the handle portion 222 must be elevated to an angle of between about 30 degrees to about 70 degrees relative to the device lid portion 202 before the link bar 206 (which is attached to the device housing 110 through a lid pin 208) pushes the pin 220 to engage a terminal end of the elliptical slot opening 216 to cause the cover 112 to begin pivoting to an open position.

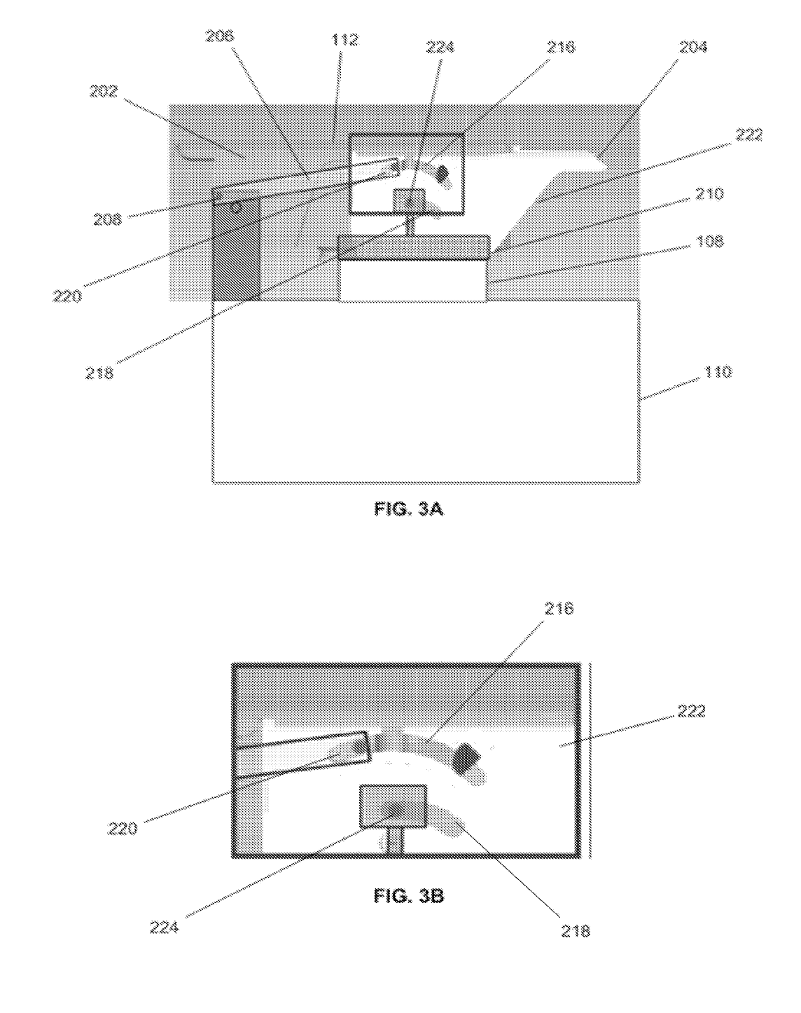

The sample block platen 210 is operably connected to the handle portion 222 such that the sample block platen 210 is positioned against the sample block 108 when the handle portion 222 is flush with the device lid portion 202. FIG. 2A depicts the distal side of the handle portion 222 in an elevated position and FIG. 3A shows the distal side of the handle portion 222 in a flushed position relative to the device lid portion 202. As shown therein, when the handle portion 222 is moved by a user to a flushed position relative to the device lid 202 portion, pressure is applied at the same time to the sample block platen 210 such that it is pressed against the sample block 108 with sufficient force to create a thermal seal between the sample block platen 210 and the sample block 108. The mechanism by which this occurs is clearly shown in FIG. 3B which provides an expanded view of how the platen pin 224 latches onto the platen slot opening 218 of the handle portion 222. When a user applies force to push the distal side of the handle portion 222 so that it is flush with the device lid portion 202, the platen pin 224 engages a terminal end of the platen slot opening 218 to cause the sample block platen 210 to be pushed down with a similar amount of force as the user applies to the handle portion 222.

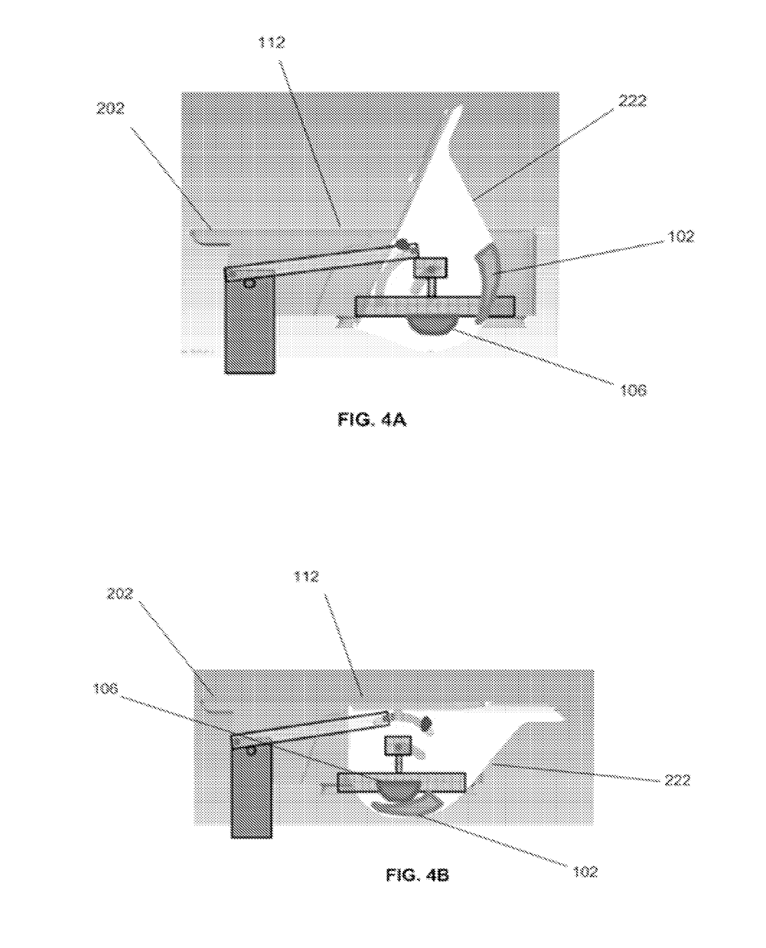

FIG. 4A is an illustration of an unlatched cover 112 and FIG. 4B is an illustration of a latched cover 112, in accordance with various embodiments. As shown herein, the cover 112 includes a handle portion 222 that has a latch 102 that is configured to latch onto a latch block 106 that is attached to the drip pan housing the sample block when the handle portion 222 is flush with the device lid portion 202. In various embodiments, the latch block 106 extends from a drip pan 114 that houses the sample block 108. In various embodiments, the latch block 106 is attached to the drip pan 114 housing the sample block 108.

In this detailed description of the various embodiments, for purposes of explanation, numerous specific details are set forth to provide a thorough understanding of the embodiments disclosed. One skilled in the art will appreciate, however, that these various embodiments may be practiced with or without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of the various embodiments disclosed herein.

What is claimed is:

1. A thermal cycler system, comprising:
a device housing including:
a sample block with a top and a bottom surface, and
a thermal electric device in thermal communication with the bottom surface; and
a cover operably connected to the device housing, the cover including:
a handle portion,
a device lid portion attached to a proximal side of the handle portion with a pin,
a sample block platen operably connected to the handle portion such that the sample block platen is positioned against the sample block when the handle portion is flush with the device lid portion and the cover is in a closed position, and
a link bar operably connected to the device housing and the pin such that a distal side of the handle portion is elevated away from the device lid portion when the cover is moved to an open position.

2. The thermal cycler system, as recited in claim 1, further including a drip pan that houses the sample block.

3. The thermal cycler system, as recited in claim 2, wherein the drip pan further includes a latch block.

4. The thermal cycler system, as recited in claim 3, further including a latch that protrudes from the distal side of the handle portion, wherein the latch is configured to latch onto the latch block when the handle portion is flush with the device lid portion.

5. The thermal cycler system, as recited in claim 1, wherein the pin protrudes from the device lid portion and latches onto an elliptical slot opening on the proximal side of the handle portion.

6. The device cover, as recited in claim 5, wherein the pin is an unbroken part of the device lid portion.

7. The device cover, as recited in claim 5, wherein the pin is a separate part that is attached to the device lid portion.

8. The thermal cycler system, as recited in claim 5, wherein the elliptical slot opening is configured to allow the distal side of the handle portion to elevate between an angle of about 30 degrees to about 70 degrees relative to the device lid portion when the cover is moved to an open position.

9. The thermal cycler system, as recited in claim 1, wherein the sample block platen thermally seals the sample block when the handle portion is flush with the device lid portion and when the cover is in a closed position.

10. The thermal cycler system, as recited in claim 1, wherein the sample block platen is connected to handle portion with a platen pin that latches onto a platen slot opening on the proximal side of the handle portion.

11. The thermal cycler system, as recited in claim 1, wherein the handle portion further includes a grip configured to provide a gripping surface to allow a user to hold the handle portion.

12. The thermal cycler system, as recited in claim 1, wherein the sample block platen latches onto a slot opening on the proximal side of the handle portion.

13. The thermal cycler system, as recited in claim 12, wherein the slot opening is configured to retract the sample block platen towards the cover when the distal side of the handle portion is elevated.

14. The thermal cycler system, as recited in claim 13, wherein the slot opening is configured to extend the sample block platen away from the cover when the cover is in an open position.

15. A device cover, comprising:
a handle portion;
a device lid portion attached to a proximal side of the handle portion with a pin; and
a link bar operably connected to a device housing and the proximal side of the handle portion such that a distal side of the handle portion is elevated away from the device lid portion when the cover is moved to an open position.

16. The device cover, as recited in claim 15, wherein the pin protrudes from both sides of the device lid portion and latches onto elliptical slot openings on both sides of the proximal side of the handle portion.

17. The device cover, as recited in claim 16, wherein the pin is an unbroken part of the device lid portion.

18. The device cover, as recited in claim 16, wherein the pin is a separate part that is attached to the device lid portion.

19. The device cover, as recited in claim 16, wherein the elliptical slot openings are configured to allow the distal side of the handle portion to elevate between an angle of about 30 degrees to about 70 degrees relative to the device lid portion when the cover is moved to an open position.

20. The device cover, as recited in claim 15, wherein the handle portion further includes a grip configured to provide a gripping surface to allow a user to hold the handle portion.
